(19) United States
(12) Patent Application Publication
(10) Pub. No.: US 2002/0159620 A1
(43) Pub. Date: Oct. 31, 2002

(54) System for automatically detecting eye corneal striae using reflected rings of light

(75) Inventors: Roy E. Williams, Collierville, TN (US); James F. Freeman, Memphis, TN (US)

Correspondence Address: David P. Gordon, Esq., 65 Woods End Road, Stamford, CT, 06905, US

(73) Assignee: Memphis Eye & Cataract Associates Ambulatory Surgery Center (dba MECA Laser and Surgery Center)

(21) Appl. No.: 10/008,884

(22) Filed: Nov. 8, 2001

Related U.S. Application Data
(63) Continuation-in-part of application No. 09/842,539, filed on Apr. 26, 2001.

(51) Int. Cl. G06K 9/00

(52) U.S. Cl. 382/128; 382/203

(57) ABSTRACT

An automated eye corneal striae detection system for use with a refractive laser system includes a cornea illuminator, a video camera interface, a computer, and a video display for showing possible eye corneal striae to the surgeon. The computer includes an interface to control the corneal illuminator, a video frame grabber that extracts images of the eye cornea from the video camera, and is programmed to detect and recognize eye corneal striae. The striae detection algorithm finds possible cornea striae, determines their location, or position, on the cornea and analyzes their shape. After all possible eye corneal striae are detected and analyzed, they are displayed for the surgeon on an external video display. The surgeon can then make a determination as to whether the corneal LASIK flap should be refloated, adjusted or smoothed again.

This application is a continuation-in-part of U.S. Ser. No. 09/842,539 filed Apr. 26, 2001, which is hereby incorporated by reference herein in its entirety.

The U.S. Government has a paid-up, non-exclusive license in this invention as provided for by Grant No. 1R43 EY13349-01 awarded by the to National Eye Institute of the National Institutes of Health.

### BACKGROUND

1. Field of the Invention

The present invention relates to ophthalmic surgical procedures for the correction of refractive error. More particularly, the present invention relates to an ophthalmic refractive correction procedure known as LASIK, wherein a corneal flap is produced. Still more particularly, the present invention relates to an ophthalmic instrument and method, which automates the detection of eye corneal striae, or corneal wrinkles, following the LASIK procedure.

2. State of the Art

Laser refractive surgery has become a very popular method for providing patients with better vision. The majority of laser refractive surgery patients will have the procedure termed LASIK (Laser In-Situ Keratomileusis) performed. There are some very important advantages that have caused LASIK to be used over the original Photo-Refractive Keratectomy (PRK) technique. For example, the healing process is usually shorter and more comfortable for the patient and larger refractive corrections can be performed.

In the LASIK procedure a microkeratome device is used to create a thin “flap”, typically 120 to 160-microns in depth and typically 7 to 11-millimeters in diameter, in order to expose the corneal stroma below. The flap is not cut completely across the cornea, thus leaving a hinge. The flap is gently lifted off the cornea and held to the side while the laser system delivers the treatment profile into the cornea stroma (tissue directly underneath the flap). After the laser delivery is completed, the flap is put back in place and smoothed by the surgeon. Within about 2 minutes, the flap is reattached enough such that the lid speculum, which is used to hold the eye open, may be removed, thus allowing the patient to blink. At this point the laser refractive procedure is completed.

Although this procedure does possess many advantages over PRK, it has one drawback that can cause postoperative refractive problems for the patient. The drawback is termed corneal flap striae, which is basically a wrinkle in the corneal flap, created when the flap is not uniformly reattached to the cornea. This striae, or wrinkle, can cause vision problems in the patient ranging from glare to acuity problems due to irregular astigmatism.

Presently, there are two approaches to reducing or eliminating eye corneal striae. The first approach is a preventative method. Here, in one technique, methods and tools have been developed to visibly mark the cornea before the LASIK flap is made. These markings are then used to realign the flap when it is put back in place. U.S. Pat. No. 5,934,285 (1999) and U.S. Pat. No. 5,697,945 (1997) both to Kritzinger, et. al. describe tools that provide various visible markings to aid in realignment. However, even this technique does not guarantee that there will be no striae present nor does it automate the detection of striae. In another technique described in U.S. Pat. No. 6,019,754 to Kawesch, filtered compressed air is applied to the corneal flap to improve flap adherence. Again, it only addresses flap adherence; it does not address the detection of eye corneal striae.

The second current approach attempts to detect striae after the flap has been put back in place. Currently, there are two dominant methods for attempting to detect striae after the LASIK procedure. Both methods are manual, as opposed to automated, techniques performed by the surgeon. In the most popular method, the refractive surgeon checks the “smoothness” of the cornea, with just the operating microscope and the diffuse, broadband, white light source present with the operating surgical microscope. Here, the surgeon is just making a broad visual determination if striae are present. In a second less popular, but more effective method, the surgeon uses a handheld slit lamp, which projects a thin line of visible broadband, white light onto the cornea. The surgeon scans this line across the cornea and looks for aberrations, or edges, on what otherwise should be a smooth surface. Usually, only two to three scans are made at different angles on the cornea and thus striae can be, and often are, missed at the other angles that are not addressed.

Neither of these two present approaches for reducing or eliminating eye corneal striae addresses the automatic detection of eye corneal striae following LASIK refractive surgery.

Outside the ophthalmic field, U.S. Pat. No. 5,764,345 to Fladd, et al., presents a method for detecting inhomogeneities, specifically striae, in infused silica glasses. This technique was developed for cases where a sample, such as a glass optical lens, can have a beam of light passed through it such that an instrument on the other side of the lens can detect it. This detector is part of an expensive interferometer system used to measure the striae present in the glass. This approach would not work for eye corneal striae detection, as one cannot place a detector on the other side of the cornea. Additionally, the interferometer requires precise alignment and would be too expensive for this application.

Thus, there is no present method for automatically detecting eye corneal striae following LASIK refractive surgery.

### SUMMARY OF THE INVENTION

It is therefore an object of the invention to provide an automated technique for detecting eye corneal striae after LASIK refractive surgery, which is more precise and more complete than existing manual techniques.

It is another object of the invention to provide an automated technique for detecting eye corneal striae after LASIK refractive surgery, which is faster than existing manual techniques.

It is a further object of the invention to provide an automated technique for detecting eye corneal striae after LASIK refractive surgery which will aid in the reduction of patient revisits to correct eye corneal striae problems.

It is an additional object of the invention to provide an automated technique for detecting eye corneal striae after LASIK refractive surgery, which is capable of being retrofit to existing refractive laser systems without modifying any hardware in the existing laser system.

In accord with these objects an automated eye corneal striae detection system is provided for use with a refractive laser system, which produces a laser for surgically reshaping the eye. The automated eye corneal striae detection system includes a means for illuminating the cornea of the eye (corneal illuminator), a means for capturing images of the eye, a computer, and a video display to present possible corneal striae to the surgeon. The corneal illuminator preferably includes an apparatus for concentrating multiple circles of light at predetermined locations comprising a ring shaped housing with a plurality of circularly shaped openings. Within the housing at each circular opening is a plurality of holders for light sources for beams of light, preferably those light wavelengths that are reflected by the cornea, directed out of the circular openings. The computer preferably includes an opto-isolated, digital input-output printed circuit board, which controls the illuminating apparatus although any digital input-output printed circuit board will suffice; and a video frame grabber, which captures images from a camera on the laser system. The computer is programmed to perform an automated eye corneal striae detection algorithm with respect to the images. The automated eye corneal striae detection algorithm finds possible striae in the images and calculates their position and shape characteristics. The possible striae are then displayed on the video display so that the surgeon can make a determination as to whether the corneal flap should be refloated, adjusted or smoothed again.

The present invention overcomes many of the problems associated with existing manual methods and tools used to prevent and detect eye corneal striae, or corneal wrinkles, after LASIK refractive surgery, by automating the eye corneal striae detection process with a computer-based analysis system.

The automated eye corneal striae detection system may be retrofit to existing refractive laser systems. Additionally, the automated eye corneal striae detection system may be provided as an integral part of a new refractive laser surgery system. If the corneal illuminator is provided as part of a new surgery system, it can also replace the ring illuminator used for visual lighting by providing the same functionality as the ring illuminator.

Additional objects and advantages of the invention will become apparent to those skilled in the art upon reference to the detailed description taken in conjunction with the accompanying drawings.

### BRIEF DESCRIPTION OF THE DRAWINGS

FIG. 1 is a schematic view of a refractive surgery system microscope provided with a corneal illuminator, an automated eye corneal striae detection computer system, and a surgeon's video display according to the invention;

FIG. 2A is a perspective view of a corneal illuminator according to the invention shown attached to a refractive surgery system microscope disposed above an eye being analyzed;

FIG. 2B is a schematic elevation view showing the corneal illuminator juxtaposed with a microsurgery microscope and the surface of the eye and additionally showing a cross section of the circular light beams directed to the cornea;

FIG. 2C is a schematic, upwardly-directed, view taken on line 2C-2C in FIG. 2B and showing the circular ring openings;

FIG. 2D shows a printed circuit board with illumination light sources installed and interface cable connector port along with dashed lines describing radial positions of each set of illumination light sources for each ring;

FIG. 3 is a schematic view of the corneal illuminator electronics interface subsystem according to the invention;

FIG. 4 is a flow chart describing the method of corneal striae detection according to the invention;

FIG. 5 shows all rings illuminated on the cornea during the analysis portion of the invention;

FIG. 6 shows the processed, detected inner and outer edges of the illuminated rings on the cornea within a region-of-interest;

FIG. 7A describes an example of a combination of only two rings illuminated on the cornea during the analysis according to the invention;

FIG. 7B shows the processed, detected inner and outer edges of the two rings described in FIG. 7A along with the detection of two possible striae objects;

FIG. 7C shows the detected possible striae after all processing has been completed on the two rings described in FIG. 7A;

FIG. 8 is an alternate video camera position and attachment method along with a cross section of the circular light beams directed to the cornea;

FIG. 9 is an alternate striae recognition algorithm according to the invention;

FIG. 10 shows a schematic view of an alternative corneal illuminator electronics interface subsystem using fiber optic illumination; and

FIG. 11 shows a digitally captured image of an eye with possible striae highlighted.

### REFERENCE NUMERALS IN DRAWINGS

20 refractive surgery system operating microscope

21 circular ring openings

22 ring illuminator housing

24 illumination light sources

25 corneal illuminator interface cable

26 circular light source beam five

27 circular light source beam four

28 cornea

29 eye

30 circular light source beam three

31 iris

32 illumination ring of light one

33 illumination ring of light two

34 illumination ring of light three

35 illumination ring of light four

36 illumination ring of light five

37 circular light source beam two

38 circular light source beam one

40 microscope optics

41 pupil

42 video camera optical port

44 video camera

46 automated eye corneal striae detection computer system

48 opto-isolated corneal illuminator PC interface board

50 video camera interface

52 frame grabber

54 eye corneal striae recognition processor

56 video display interface

58 corneal illuminator electronics interface subsystem

60 corneal illuminator

62 surgeon's video display

70 interface cable

74 electrical current limiting resistors

80 Automated Eye Corneal Striae Detection Algorithm

82 Turn ON LEDs

84 Send ON Signal to Control Electronics

86 Receive Digitized Image

88 mask out striae area in image

90 apply nonlinear edge detection operator

92 apply thresholding technique

94 apply outer gradient operator

96 apply particle filter

98 get particle parameters from particle filter

99 create ideal circles from particle filter results and subtract from processed outer and inner edges

100 all rings processed (decision activity)

102 outline possible corneal striae

104 show possible corneal striae on display

106 process digital image again (decision activity)

108 detection algorithm done

120 illumination light source printed circuit board

122 illuminator interface connector port

124 clearance space

126 mounting fasteners

128 ring illuminator housing mounting bracket

132 dashed lines showing radial position of each set of illumination light sources for each ring of illumination

134 large clearance hole (in PCB)

136 region-of-interest (ROI)

138 eye optical axis

140 mounting bracket

142 video camera lens

144 alternative fiber optic corneal illuminator electronics interface subsystem

146 fiber optic corneal illuminator interface bundle

148 fiber optic illumination light sources

150 video camera cable

152 video display cable

160 pattern matching technique

162 get matched particle parameters

163 outer edge of illumination ring of light five

165 inner edge of illumination ring of light five

167 outer edge of illumination ring of light four

169 inner edge of illumination ring of light four

171 outer edge of illumination ring of light three

173 inner edge of illumination ring of light three

175 outer edge of illumination ring of light two

177 inner edge of illumination ring of light two

179 outer edge of illumination ring of light one

181 inner edge of illumination ring of light one

183 first possible striae object

185 second possible striae object

187 possible striae highlighted

### DETAILED DESCRIPTION OF THE PREFERRED EMBODIMENTS

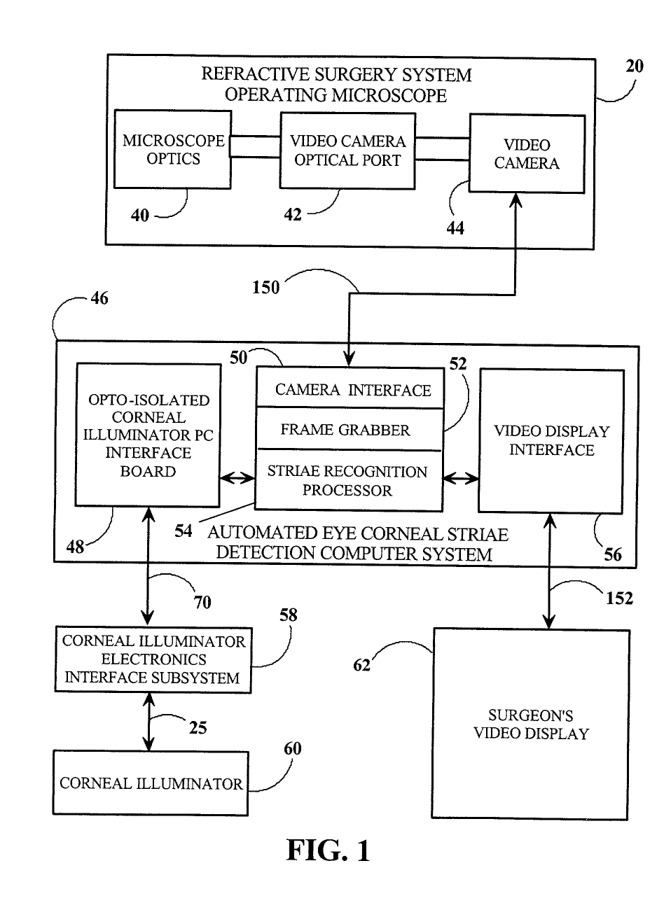

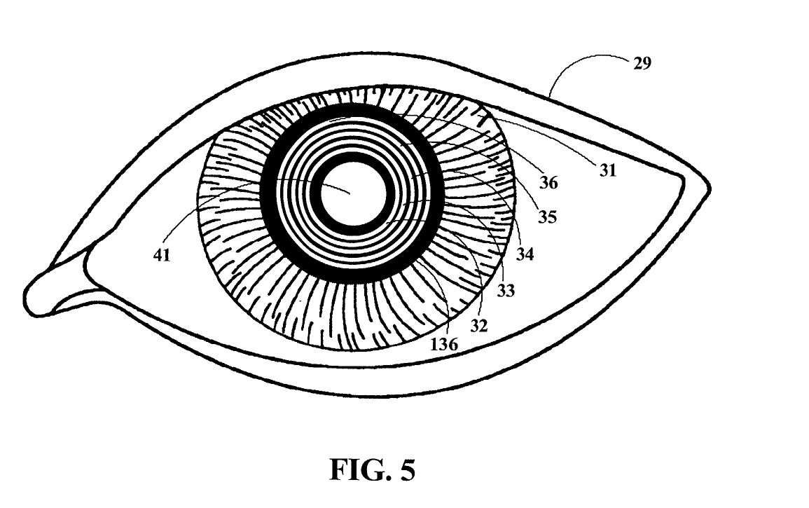

Turning now to FIG. 1, a refractive surgery system operating microscope 20 is coupled to an automated eye corneal striae detection computer system 46 of the invention. The refractive surgery system operating microscope 20 includes a set of microscope optics 40 allowing the surgeon adequate view of the corneal surface and a video camera optical port 42 optically coupling the image the surgeon views to a video camera 44, e.g., a Teli CS6460, that is used to capture a corneal image (FIG. 5).

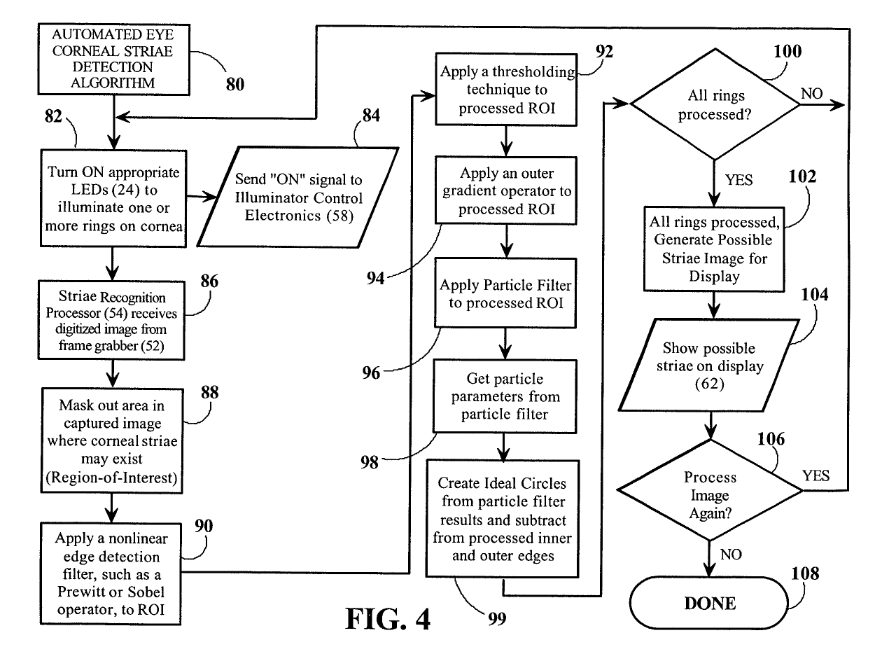

The automated eye corneal striae detection computer system 46, e.g., a Compaq Deskpro EN, 450-MHz PC, generally includes a video camera interface 50 that is coupled to the video-out port of the video camera 44 through a video camera cable 150, and a frame grabber 52, e.g., a National Instruments PCI 1411. The computer system 46 also includes a video display interface 56 that is coupled to a surgeon's video display 62 through a video display cable 152, and an opto-isolated corneal illuminator PC interface board 48, e.g., a National Instruments PCI-6527. In addition, the computer system 46 includes an eye corneal striae recognition processor 54, which implements a software algorithm 80 for striae detection as discussed below with respect to FIG. 4.

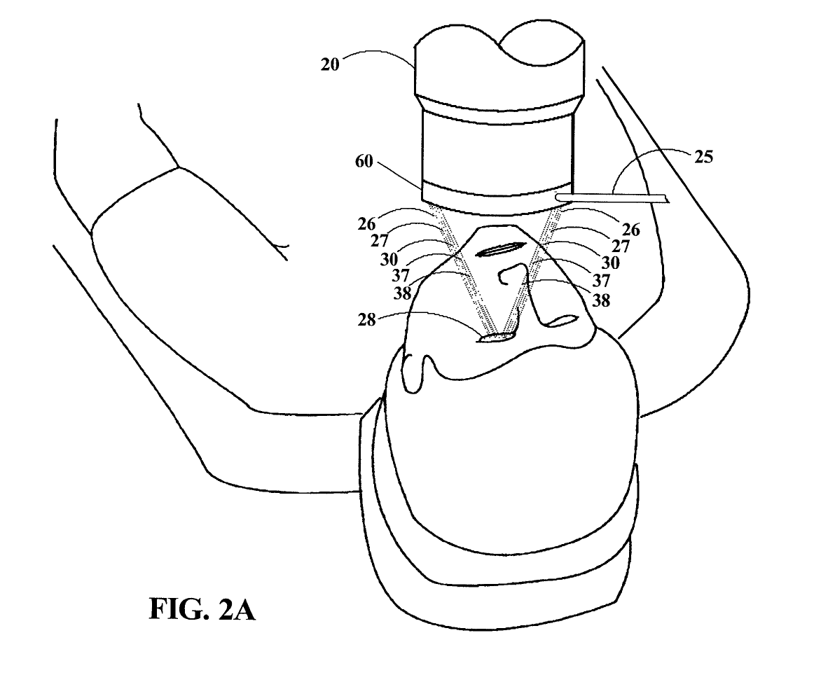

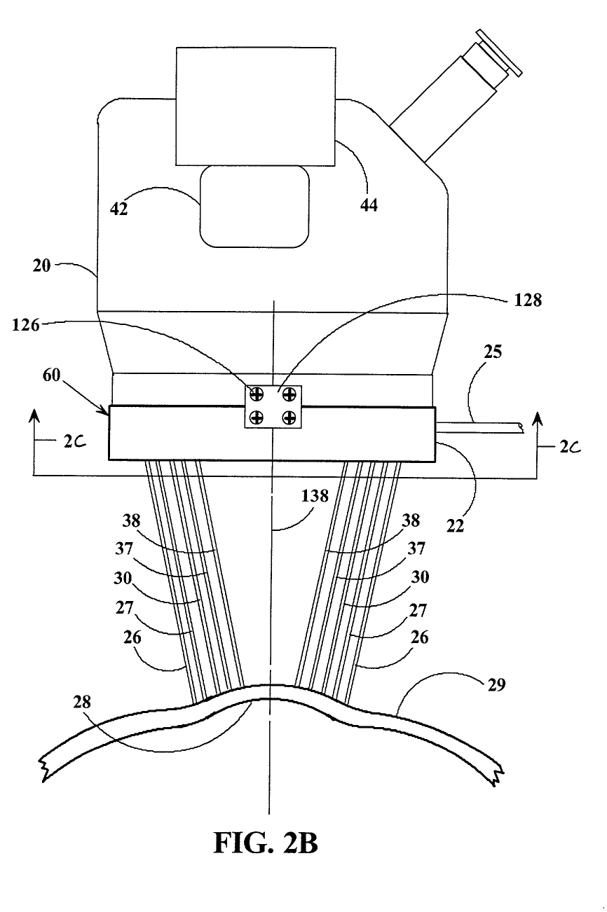

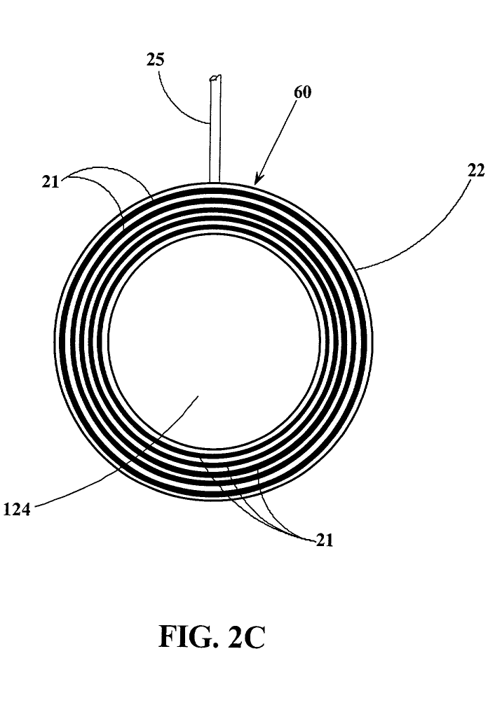

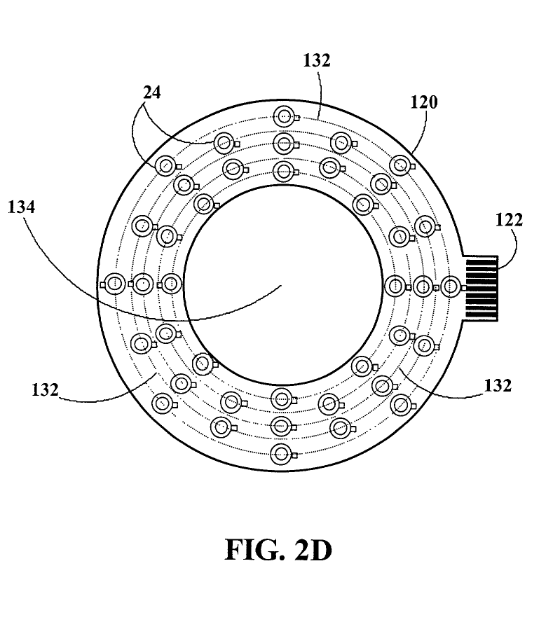

Referring to FIG. 2A, a corneal illuminator 60, attached to the refractive surgery system operating microscope 20, is shown in relationship to a patient's cornea 28. Referring to FIG. 2B, the corneal illuminator 60 includes a ring illuminator housing 22 and an illumination light source printed circuit board 120 (FIG. 2D). The ring illuminator housing 22 is constructed and arranged to be mounted on the base of the refractive surgery system operating microscope 20. A ring illuminator housing mounting bracket 128 and a set of mounting fasteners 126 are used to mount the corneal illuminator 60 to the refractive surgery system operating microscope 20, although other mounting methods may be used.

Ring illuminator housing 22 is in the form of a preferably continuous ring having an inner diameter generally sufficient to ensure an adequate clearance space 124 so as not to interfere with the delivered laser beam or the optical view of the surgeon (FIG. 2C). In the preferred embodiment, the diameter of the clearance space 124 is approximately 50 mm. Ring illuminator housing 22 is also provided with a plurality of radially arranged (as indicated by dashed line 132) circular openings 21 that are preferably evenly spaced (though may be otherwise spaced) around the ring illuminator housing 22, and from which circular light source beams 26, 27, 30, 37 and 38, described below, emerge to illuminate the cornea 28.

Referring to FIG. 2D, the illumination light source printed circuit board 120 includes illumination light sources 24. The light sources are preferably a plurality of white light emitters, although any preferably monochromatic light source wavelength that is reflected by the cornea is applicable, which may be fiber bundles, light emitting diodes, etc. In the preferred embodiment, forty bright white light emitting diodes, e.g., Lumex SSL-LX3054UWC/A, serve as the illumination light sources 24, and when spaced evenly around ring illuminator housing 22 provide sufficient illumination for the corneal striae detection algorithm. A greater or fewer number of illumination light sources 24 may be employed. The printed circuit board has a large clearance hole 134 preferably coaxial with clearance space 124 so as not to interfere with the delivered laser beam or the optical view of the surgeon. Alternatively, though less preferably, other light sources such as incandescent lamps, halogen lamps, etc. can be used.

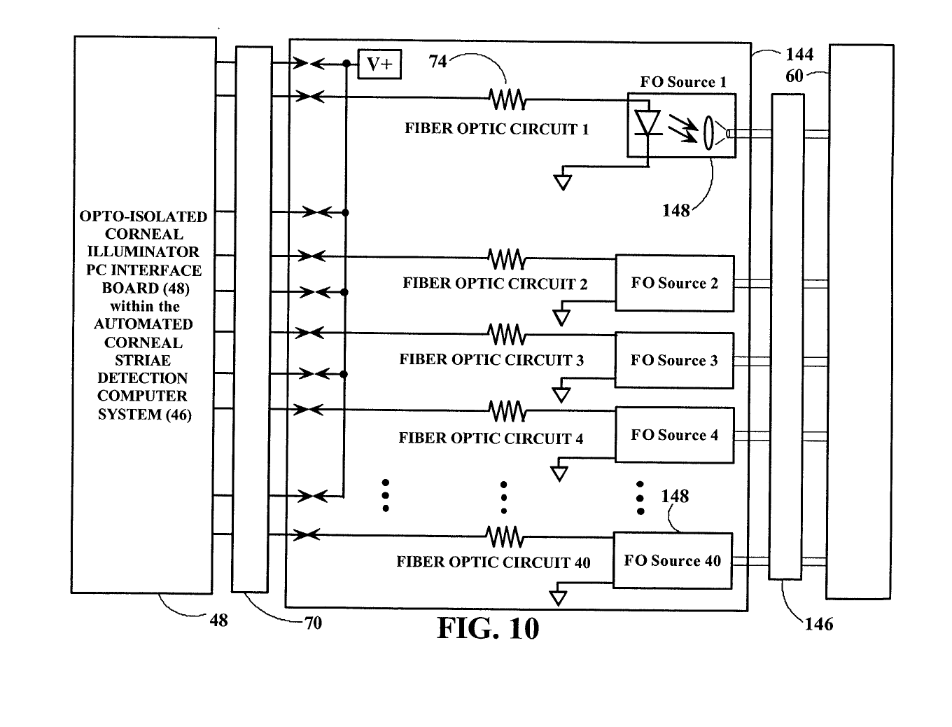

A corneal illuminator interface cable 25 connects to the illumination light source printed circuit board 120 at an illuminator interface connector port 122, shown as an edge card connector arrangement although other connector arrangements may be used, and to a corneal illuminator electronics interface subsystem 58. Alternatively, the illumination light sources 24 may be individually wired to the corneal illuminator interface cable 25 which connects to the corneal illuminator electronics interface subsystem 58. Even further, illumination light sources 24 may be individual fiber optic cables connected to an alternative fiber optic corneal illuminator electronics interface subsystem 144 through a fiber optic corneal illuminator interface bundle 146, as described below with respect to FIG. 10.

The light sources 24 produce circular light source beams 26, 27, 30, 37 and 38 that are directed through the circular openings 21 and projected onto the cornea 28 after an eye 29 that has undergone LASIK refractive surgery. The light source beams 38, 37, 30, 27, and 26 are directed toward cornea 28 at varying angles from an optical axis 138, e.g., 10.8°, 11.2°, 11.5°, 11.9°, and 12.25°, respectively, although other angles may be implemented.

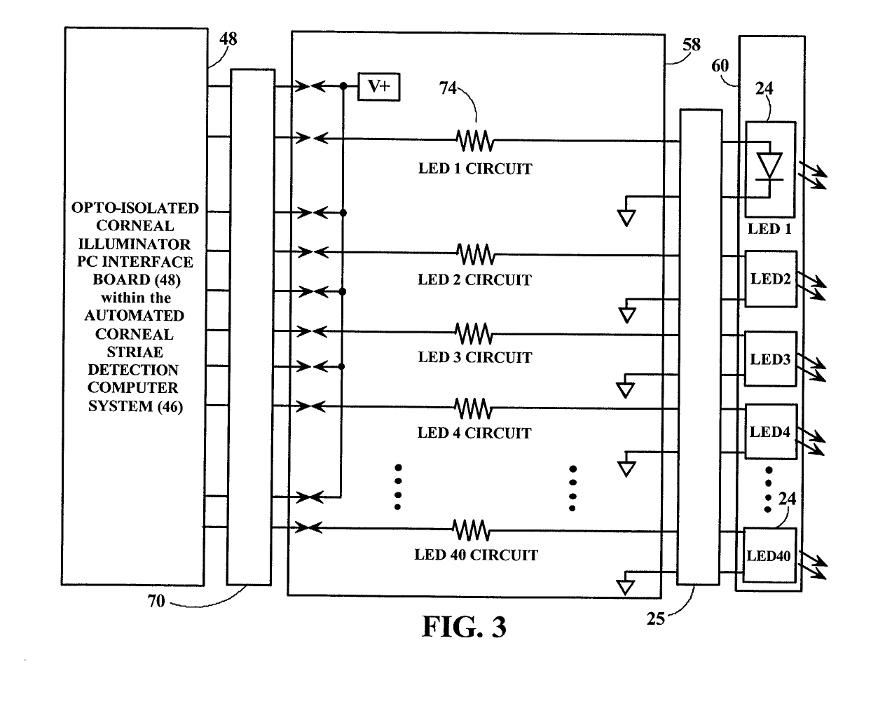

Referring to FIG. 3, the corneal illuminator electronics interface subsystem 58 is connected by corneal illuminator interface cable 25 to the corneal illuminator 60 and by an interface cable 70 to the opto-isolated corneal illuminator PC interface board 48. Control signals, from the opto-isolated corneal illuminator PC interface board 48, are coupled through electrical current limiting resistors 74 and corneal illuminator interface cable 25 to illumination light sources 24. The corneal illuminator electronics interface subsystem 58 provides the necessary electrical current (amperage) to the corneal illuminator 60 in order to adequately illuminate the cornea.

Referring to FIG. 5, the eye 29, an iris 31 and a pupil 41 are shown in relationship to illumination rings 32, 33, 34, 35 and 36 projected on the cornea from the circular light source beams 38, 37, 30, 27 and 26. Illumination ring of light 32 has a coverage area of one millimeter wide positioned at a two millimeter diameter from the center of pupil 41. Illumination ring of light 33 has a coverage area of one millimeter wide positioned at a four millimeter diameter from the center of pupil 41. Illumination ring of light 34 has a coverage area of one millimeter wide positioned at a six millimeter diameter from the center of pupil 41. Illumination ring of light 35 has a coverage area of one millimeter wide positioned at an eight millimeter diameter from the center of pupil 41. Illumination ring of light 36 has a coverage area of one millimeter wide positioned at a ten millimeter diameter from the center of pupil 41. A region-of-interest (ROI) 136 is thereby defined having a slightly larger diameter than the largest LASIK incision. In the preferred embodiment, the region-of-interest (ROI) 136 is approximately 12-mm in diameter and is centered on the pupil 41, although other ROI sizes can be used.

The apparatus of the invention is placed into operation after the LASIK surgery procedure is completed and the flap has been manipulated back to its original place by the surgeon and allowed to seal. Referring to FIG. 4, in accord with the preferred algorithm 80, the automated eye corneal striae detection computer system 46 turns on appropriate LEDs at 82 by sending out a control signal at 84 through the opto-isolated corneal illuminator PC interface board 48 to the corneal illuminator electronics interface subsystem 58. The cornea 28 is thereby illuminated with illumination rings of light 32, 33, 34, 35 and 36. The illumination rings of light can be delivered individually, all at the same time, or in any combination by sending appropriate control signals at 84.

Referring back to FIG. 1, the video camera optical port 42 to which video camera 44 is coupled is typically a microscope beam splitter optical port which permits users to attach cameras thereto for recording the surgery and audience viewing of the surgery. The automated eye corneal striae detection computer system 46 takes advantage of one of these microscope beam splitter optical ports in order to monitor the eye via a provided video camera. For example, in the VISX™ laser system, an electronic output signal port connector is provided which is attached to an internal color CCD camera. On other systems an electronic signal splitter can be attached at the output of the camera so that the video camera interface 50 and the frame grabber 52 may capture the signal. Alternatively, a separate camera may be provided with the automated eye corneal striae detection system of the invention and added to the microscope beam splitter optical port in order to capture the illuminated corneal images. That is, a number of methods and systems may be utilized to capture the image of the eye from the refractive surgery system operating microscope 20 used in performing the refractive laser surgery. The frame grabber 52 takes the signal from the video camera interface 50 and converts it to a digital signal. Alternatively, a digital camera and associated digital frame grabber, e.g., a Pulnix TMC-1000 and National Instruments PCI-1424, respectively, can be used to capture the corneal image directly in digital format.

Referring again to FIG. 4, the automated eye corneal striae detection computer system 46 receives the digitized image signal at 86 and converts the digitized image signal to a digital matrix for processing. Generally, the automated eye corneal striae detection computer system 46 (1) processes the digitized corneal image for eye corneal striae recognition, (2) determines a position and a shape characteristic profile for each detected eye corneal striae object, and (3) displays the detected eye corneal striae object to surgeon's video display 62. Each of the functions of the automated eye corneal striae detection computer system 46 is preferably performed by the algorithm 80, which is now described in detail.

Once the digitized eye corneal image is received at 86 there are several image processing methods that can be used to find eye corneal striae. One preferred method implemented by the eye corneal striae recognition processor 54 uses the contrast between the reflected illumination rings of light and the non-reflected surface of cornea 28. Each captured, digitized illumination ring of light is compared against calculated, digitized ring objects (defined by ideal circles) to detect the striae, which distorts the reflected illumination ring of light where present, and determines the striae's position and shape characteristic profile, preferably by the following ten steps.

First, a small area of the captured image is masked out at 88 so as to limit the region-of-interest (ROI) 136 (FIG. 5) for detecting the eye corneal striae. This region of interest is slightly larger than the LASIK incision, and in the present embodiment consists of a 12 mm diameter circular area centered on the pupil 41.

Second, image data from the region-of-interest (ROI) 136 is then processed at 90 by an edge detection operator, preferably a Prewitt or Sobel, although other edge detection approaches can be used, to highlight edges within the ROI image. Once this operation has been performed, a bimodal image is produced.

Third, a threshold function is preferably applied to the bimodal image at 92 to create a binary representation of the image, which permits faster image processing. The threshold function replaces the image intensity values below some threshold value to black (a value of zero) while placing the intensity values above the threshold value to all white (a value of 256 in an 8-bit image representation); i.e., a binary representation of the image is created. At this step the edges of the captured, digitized illumination ring of lights within the ROI image are now totally white against a black background.

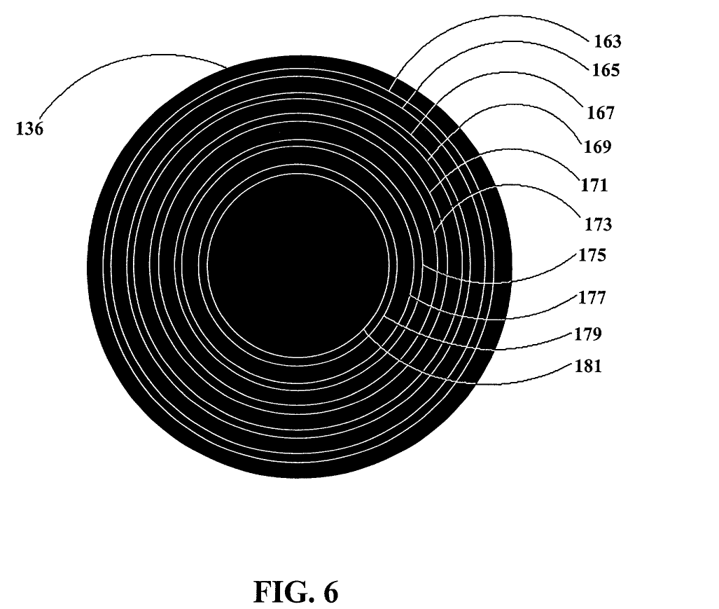

Fourth, the binary representation is preferably further processed at 94 by an outer gradient operator. In this operation an external edge algorithm subtracts the source ROI image from a dilated image of the source ROI image. The remaining image pixels correspond to the pixels added by the dilation. This yields a more pronounced image of the edges 163, 165, 167, 169, 171, 173, 175, 177, 179 and 181 of the captured, digitized illumination ring of lights 36, 35, 34, 33 and 32, respectively (FIGS. 6 and 5, respectively).

Fifth, at 96, the processed binary ROI image undergoes a characterization process, termed a particle filter, to determine a set of parametric values from the image. Since all captured, digitized illumination rings of light 36, 35, 34, 33 and 32 will be circular, or nearly circular, processed outer and inner edges 163, 165, 167, 169, 171, 173, 175, 177, 179 and 181, respectively, will be circular in shape and within a known diameter (less than 12 mm in the preferred disclosed embodiment). Thus, the search of the binary objects can be limited to a range defined by the dimensions and shape characteristics of the illumination rings of light 36, 35, 34, 33 and 32. A search is then performed on the binary image for objects matching the criterion. Those objects found in this range are returned with several pieces of shape characteristic information, termed a shape characteristic profile.

Sixth, at 98, the shape characteristic information (particle parameters) is extracted from the particle filter and saved for future processing. Such pieces of shape information include, but are not limited to, object position, center of mass, bounding box coordinates, perimeter length, circularity, etc.

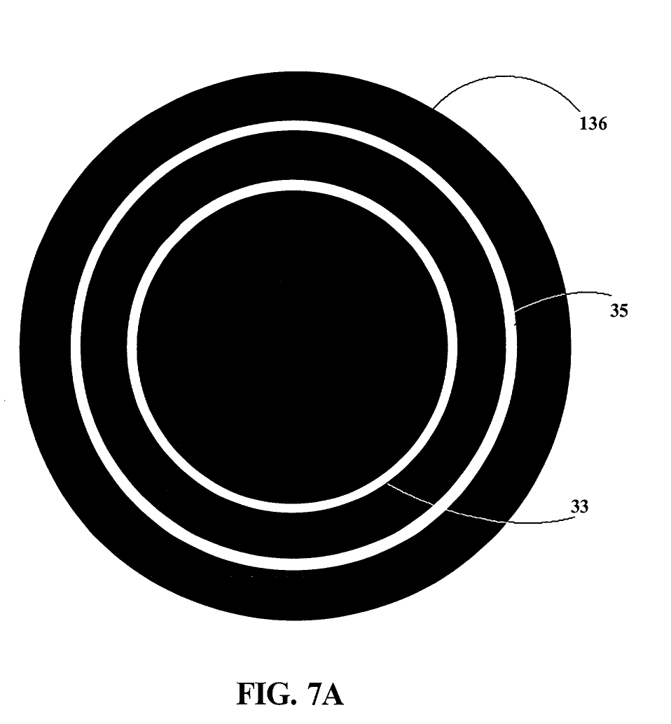

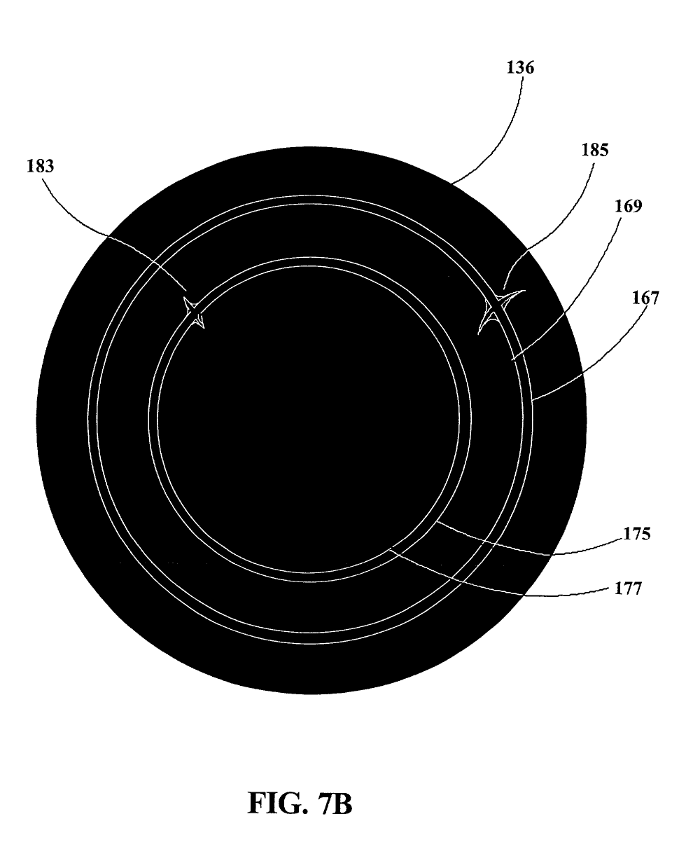

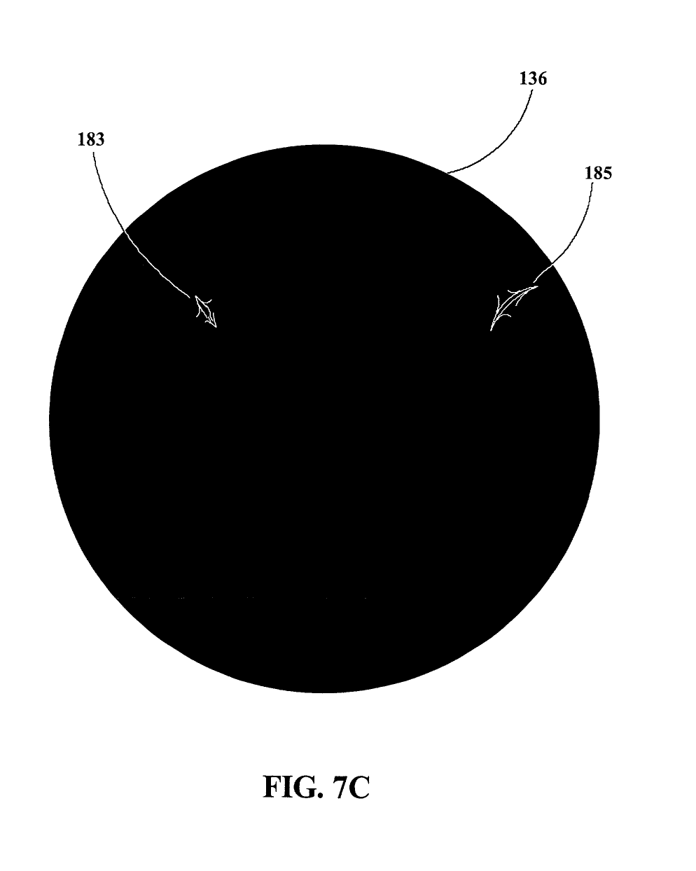

Seventh, at 99, the shape information found at 98, in particular the bounding box coordinates and the object position coordinates, is used to create the ideal circles with diameters and positions based on processed outer and inner edges 163, 165, 167, 169, 171, 173, 175, 177, 179 and 181. The created ideal circles are then subtracted from the processed outer and inner edges 163, 165, 167, 169, 171, 173, 175, 177, 179 and 181 determined at 96 yielding possible striae objects. Examples of two possible striae objects are shown in FIG. 7B as first possible striae object 183 and second possible striae object 185. Any possible striae objects are saved for later display at 104.

Eighth, at 100, the algorithm decides whether all illumination rings of light have been processed. This is based on whether all illumination rings of light 32, 32, 34, 35 and 36 are projected at the same time (FIG. 5); projected individually; or projected in any combination. In the preferred embodiment, five illumination rings of light are processed at once, although there could fewer or more. FIG. 7A describes another possible method where a combination of only two illumination rings of light 33 and 35 are processed at the same time. After rings of light 33 and 35 are processed, other rings are processed together or alone. Yet another possible method would be to process each illumination ring of light individually. For the individual processing method, if all illumination rings of light have not been processed the algorithm returns to 82 to begin the next illumination ring of light process. After illumination ring of light 32 is processed, illumination ring of light 33 is processed followed by illumination ring of light 34, etc., until all illumination rings of light have been processed. Once all illumination rings of light have been processed, the algorithm then continues on to display the results.

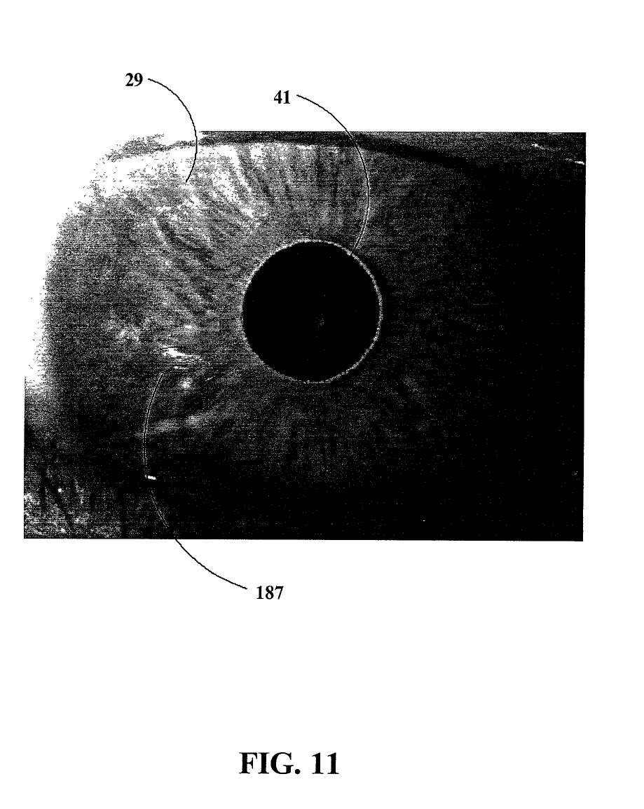

Ninth, at 102, the monochrome (black and white) binary eye corneal striae image is enhanced by outlining possible striae found in 99 with a high-contrast color, such as red, yellow or green, although other high-contrast colors would suffice, so that the possible corneal striae are obvious to the surgeon. This new generated image (FIG. 11) is then sent to surgeon's video display 62 for viewing by the surgeon or other medical practitioner, with the possible corneal striae 187 highlighted. (It is noted that the striae displayed in FIG. 11 do not correspond in location to the possible striae identified in FIGS. 7B and 7C.)

Tenth, at 106, the surgeon is given the option to repeat the process. This may occur after the surgeon has smoothed a striae or wrinkle, or when the surgery procedure is complete. If the surgeon requires another process, algorithm control is sent back to 82 and the procedure repeats. If the surgeon indicates the procedure is complete, the algorithm is finished at 108.

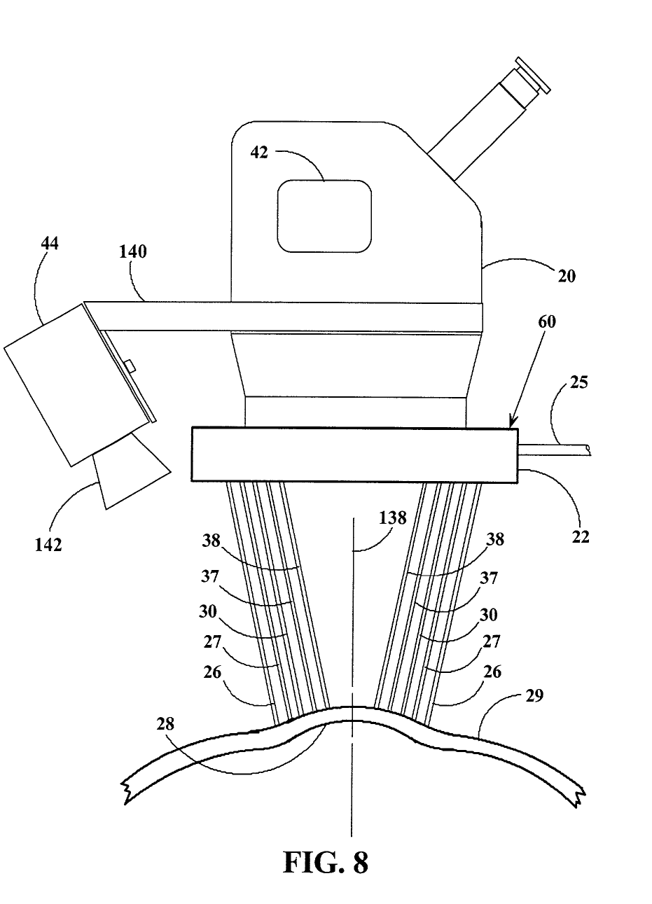

It is recognized that there may be variations on the present system and method that are within the scope of invention. By way of example, the video camera 44 may be otherwise positioned. Referring to FIG. 8, the video camera 44 is shown mounted to the refractive surgery system operating microscope 20 by a mounting bracket 140 at an appropriate angle to capture an image of the cornea and at a proper position so as not to interfere with the surgeon or surgeon's assistants. A video camera lens 142 is used to provide the automated eye corneal striae detection computer system 46 (FIG. 1) with an appropriate sized image to perform striae detection. The addition of the video camera lens 142 ensures that eye corneal striae recognition processor 54 receives a similar image as is delivered in the previous embodiment. In this embodiment the output port of the video camera 44 is connected to the video camera interface 50 in the automated eye corneal striae detection computer system 46 through the video camera cable 150 as before.

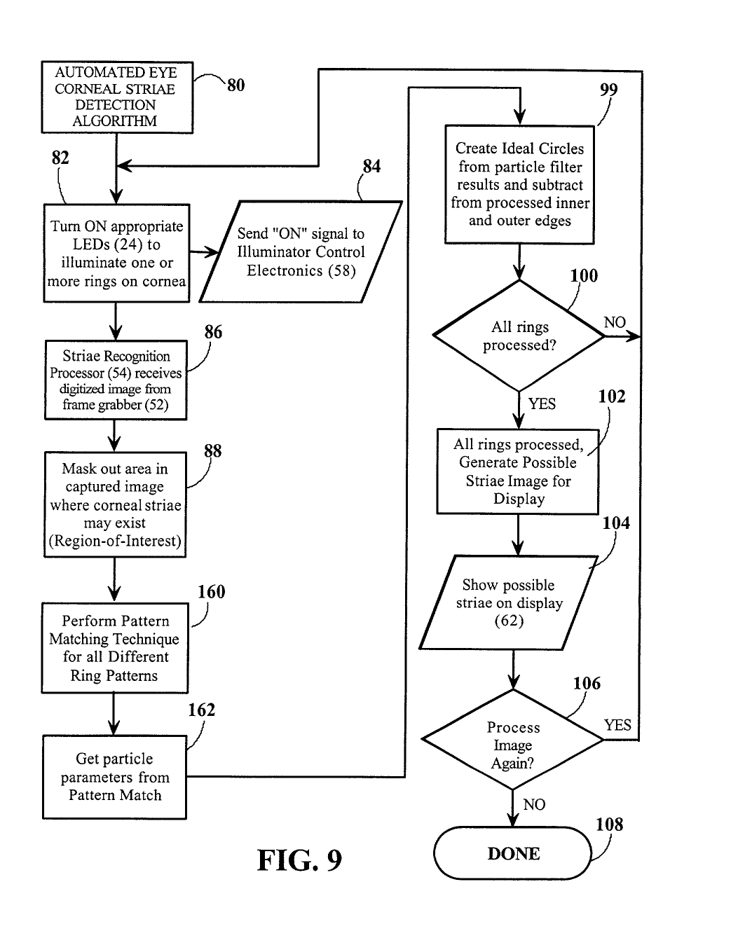

In addition, another eye corneal striae recognition approach can be used. For example, referring to FIG. 9, an eye corneal striae recognition technique involving pattern matching can be implemented at 160. As in the preferred embodiment, the cornea is illuminated with illumination rings of light 32, 33, 34, 35 and 36 at 82 and 84 in any combination; the illuminated cornea image is captured through the video camera 44 by the video camera interface 50 and the frame grabber 52 at 86; the possible corneal area (ROI) for striae is masked out at 88; and a pattern matching technique is applied at 160. This alternative pattern matching technique uses a grayscale pattern matching method based on correlation. Known, defined illumination ring objects (e.g., known diameters and widths) are scanned through the ROI image searching for a pattern match. The technique is shift-invariant, stretch or size-invariant, and rotation-invariant, and is highly immune to adverse lighting conditions, focus variations, or noise. Once an illumination ring object is found, its shape characteristic information (particle parameters), such as object position, center of mass, circularity, and bounding box coordinates, are saved at 162 as in the main embodiment algorithm, and processing then occurs as before at 99. Algorithm control continues from here as described in the main embodiment.

Turning now to FIG. 10, an alternative illumination means is shown. A fiber optic corneal illuminator electronics interface subsystem 144 includes fiber optic illumination light sources 148. The interface subsystem 144 is connected by a fiber optic corneal illuminator interface bundle 146 to the corneal illuminator 60 and by an interface cable 70 to the opto-isolated corneal illuminator and patient positioning PC interface board 48. Electrical current limiting resistors 74 couple the control signal from the opto-isolated corneal illuminator PC interface board 48 to fiber optic illumination light sources 148, e.g., an Industrial Fiber Optics IF-E97, preferably white light sources, although any monochromatic wavelength that is reflected by the cornea will suffice. Moreover, when any color monochromatic light is used (e.g., red, blue, green, etc.), either by fiber optics, LEDs, incandescent sources, etc., the circles may be processed using color techniques in which the objects are identified based on their color.

From the embodiments of the invention described above it can be appreciated that the automated eye corneal striae detection system provides a very effective method for detecting eye corneal striae, or wrinkles, that may be present after LASIK refractive surgery. Since the automated eye corneal striae detection system actually detects and displays eye corneal striae, it offers several advantages over current methods aimed at only preventing striae. Additionally, the automated eye corneal striae detection system provides detection of striae from several different angles thereby offering superior corneal coverage over current manual techniques that use only two or three angles.

While the invention has been described in accordance with what is presently considered to be the preferred embodiments, it is to be understood that the invention is not limited to the disclosed embodiments, but on the contrary, is intended to cover various modifications and equivalent arrangements. Thus, while particular functional systems have been disclosed, it will be appreciated that other functional systems may be used as well. That is, the striae recognition processor and corneal illuminator electronics interface subsystem may be combined in a single system or further divided to perform the required tasks of the invention. Furthermore, while a particular preferred method and alternative methods have been disclosed for striae detection, it will be appreciated that other algorithms may be used. For example, neural network processing techniques, which are very efficient at pattern matching, can be used. Additionally, as only one video camera has been shown, it will be appreciated that two or more video cameras could be implemented to offer an increase in processing speed as well as additional information about striae object parameters, such as height information, etc. Furthermore, while a video display is preferred for display of the striae objects to the medical practitioner, it will be appreciated that other display means, e.g., high resolution printed image or a printed schematic indicating striae location, can also be used. It will therefore be appreciated by those skilled in the art that yet other modifications could be made to the provided invention without deviating from its spirit and scope as claimed.

What is claimed is:

1. An automated eye corneal striae recognition system comprising:
a) means for projecting a plurality of concentric rings of light on an eye cornea;
b) means for capturing an image of the illuminated eye cornea; and
c) a computer system including,
(i) means for controlling said means for illuminating said eye cornea,
(ii) means for receiving said image of the eye cornea from said means for capturing said image, and
(iii) a processor means for
(A) processing said image,
(B) detecting corneal striae objects from the processed image if corneal striae are present, and
(C) if corneal striae are present, determining a respective position for each of the detected corneal striae objects.

2. An automated eye corneal striae recognition system according to claim 1, further comprising:
means for indicating to a medical practitioner the respective positions of the detected corneal striae objects relative to the eye cornea.

3. An automated eye corneal striae recognition system according to claim 2, wherein:
said means for indicating is a video display.

4. An automated eye corneal striae recognition system according to claim 1, wherein:
said light is at a wavelength adapted to be reflected by the cornea.

5. An automated eye corneal striae recognition system according to claim 1, wherein:
said light is monochromatic.

6. An automated eye corneal striae recognition system according to claim 1, wherein:
said light is white light.

7. An automated eye corneal striae recognition system according to claim 1, wherein:
said means for projecting includes,
(i) a housing having a plurality of concentrically arranged spaced openings adapted to direct light toward the eye cornea,
(ii) a supporting means within said housing for supporting a source of a light beam at each of said openings, and
(iii) means for controlling each said source of a light beam individually.

8. An automated eye corneal striae recognition system according to claim 7, wherein:
said source of a light beam is one of a fiber optic element, an incandescent bulb, and a halogen bulb.

9. An automated eye corneal striae recognition system according to claim 7, wherein:
said source of a light beam is a light emitting diode.

10. An automated eye corneal striae recognition system according to claim 9, wherein:
said supporting means for each said light emitting diode within said housing is a printed circuit board.

11. An automated eye corneal striae recognition system according to claim 1, wherein:
said means for projecting said plurality of concentric rings of light on an eye cornea projects at least one ring of light on the cornea at a first time and at least one other ring of light on the cornea at a second time.

12. An automated eye corneal striae recognition system according to claim 1, wherein:
said plurality of concentric rings is each approximately one millimeter wide.

13. An automated eye corneal striae recognition system according to claim 1, wherein:
said plurality of concentric rings includes five rings of light, with a first ring being two millimeters in diameter and centered on a pupil of the eye, a second ring being four millimeters in diameter and centered on a pupil of the eye, a third ring being six millimeters in diameter and centered on a pupil of the eye, a fourth ring being eight millimeters in diameter and centered on a pupil of the eye, and a fifth ring being ten millimeters in diameter and centered on a pupil of the eye.

14. An automated eye corneal striae recognition system according to claim 1, further comprising:
d) a laser generator for performing refractive laser surgery on the eye cornea.

15. A method for automatically detecting corneal striae, said method including:
(a) projecting at least one ring of light onto the cornea, said light adapted to be reflected by the cornea;
(b) obtaining an image of a cornea location illuminated by said at least one ring of light;
(c) processing said image; and
(d) determining from said processed image whether one or more corneal striae objects are present.

16. A method according to claim 15, wherein:
a plurality of rings of light are projected on the cornea.

17. A method according to claim 15, further comprising:
e) repeating steps (a) (d) with additional rings of light being projected onto the cornea, each of said rings of light having a distinct diameter and being concentric.

18. A method according to claim 15, wherein:
said light is monochromatic.

19. A method according to claim 15, wherein:
said light is white light.

20. A method according to claim 15, wherein:
wherein said processing includes
(i) defining a limited region-of-interest in said image for detecting the corneal striae objects,
(ii) processing image data from the limited region-of-interest by an edge detection operator such that a bimodal image is produced,
(iii) applying a threshold function to said bimodal image such that a binary representation of said image is created,
(iv) searching the binary representation image for circular objects within a predetermined diameter,
(v) extracting shape characteristic information from said image, said shape characteristic information including circularity,
(vi) creating ideal circles having diameters and positions based on said edge detection operator, and
(vii) subtracting said ideal circles from edges defined in said edge detection operator such that possible corneal striae objects are identified.
